(19) United States
(12) Patent Application Publication
(10) Pub. No.: US 2016/0378418 A1
(43) Pub. Date: Dec. 29, 2016

(54) MULTI-STORE SHELVING DISPLAY SYSTEM

(71) Applicant: Lucius Cole Pearson, Timberlake, NC (US)

(72) Inventor: Lucius Cole Pearson, Timberlake, NC (US)

(21) Appl. No.: 14/753,130

(22) Filed: Jun. 29, 2015

(51) Int. Cl. G06F 3/14; G06Q 10/08

(52) U.S. Cl. CPC G06F 3/1423; G06Q 10/087

(57) ABSTRACT

The present invention provides a system for providing prices and advertising for gondola-type shelving in retail stores. It also allows remote changes of pricing and advertising in multiple stores at the same time.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

Field of the Invention

The present invention relates to shelving pricing. In particular, it relates to a gondola type shelving display system for a multi-store environment.

Description of Related Art

Retail businesses are pressured to provide updated and accurate product pricing information to the customer at the point of purchase. Typically, the product pricing is displayed on gondola type shelving in grocery stores, pharmacies and the like. Gondola shelving is also called pegboard shelving, but includes solid backing boards that are viewed as an “island” of shelving. The benefit of this type of retail store shelving is the free standing nature of the units. In the US, the units come in 2, 3, and 4 foot sections and sometimes longer. Shelving fits onto the backing, and the front of the shelf has a price tag molding, i.e. a channel on the front of the shelf designed to place product pricing information. Pricing is placed in the price tag molding channel by placing the price tags by hand, and one of the drawbacks in recent times is the frequency that someone must go to the shelf to either update the price for the customer to see and or for workers to know where to place merchandise.

If pricing on the shelf is not done properly, then prices at the register, which are based on what's in the computer database, can charge the customer a different price, leading to customer complaints and other problems. Because changing price labels is time-consuming, it can frequently be the case that there is no time to update pricing, and this causes the discrepancies.

Electronic pricing displays, however, have been introduced and attempted with limited success. They tend to be limited to needing a display for each product and limited to needing the store employees to program the store computer to produce the correct price. While this eliminates some problems, each store must still be programmed, and failure to update the computer ends up with incorrect pricing on the shelves. In one version, in PCT application WO 00/67110 discloses use of an electrophoretic display, i.e. electronic paper, for each unit placed on a shelf, i.e. seven products on one shelf require seven labels. While again, some problems are solved, it still is a problem for situations when there are new facings with larger or smaller products and the like. Where there are a number of related stores, such as grocery store chains, even further problems exist in updating stores and keeping prices correct between stores such that one store might have one price and another store in the chain another price. This is especially true when a chain store advertises a sale price specifically for members of the store.

### BRIEF SUMMARY OF THE INVENTION

The present invention relates to a system which solves the problems above and provides even further benefits as will be seen from the description of the invention. The invention relates to producing a single flat panel display that fits into the length of each price tag molding for each shelf. Then, a central computer determines the price and the width of the price on the shelf centrally and then transmits the information directly to the shelf. In addition, advertising and other messages can be positioned in between price labels on the flat panel display where there is room, adding to the value of the shelving information.

Accordingly, in one embodiment there is a system for shelf pricing in multiple stores comprising
a) a plurality of merchandise stores, each store having one or more gondola shelves displaying merchandise and each shelf having a length, and having a price tag molding, each molding having a length about the length of each shelf;
b) a flat panel display positioned in each price tag molding, the display being about the length of the price tag molding, each flat panel display having an electronic means of identification; and
c) a central computer in electronic communication with each of the identified flat panel displays in the plurality of merchandise stores, the computer having software in resident memory which allows a user of the central computer to position price information next to any of the displayed merchandise from the central computer on at least one flat panel display in at least two stores simultaneously.

### BRIEF DESCRIPTION OF THE DRAWINGS

FIG. 1 is a schematic of the system of the present invention.

FIG. 2 is a flow chart of the method of the present invention.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one.

The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “shelf pricing” refers to the placement of information relating to a product sitting on the shelf next to the price on the shelf (usually the price is below the product). Price information includes product price, unit price (such as price per ounce), bar codes, product name and the like, etc.

As used herein the term “merchandise stores” refers to retail or discount stores which have gondola shelving with price tag molding for the placement of standard product pricing labels. Examples are food stores, drug stores, home improvement stores, gift stores and the like.

As used herein the term “display merchandise” refers to products which sit on a shelf for the purchaser (usually the public or the like) to see and decide to purchase or not. One or more products can sit on each shelf, each with a price from the system. Where there are multiple products (facings) of the same product, a price can be underneath each product or only under one product.

As used herein the term “gondola shelf or shelves” refers to standard island type shelving wherein there is a flat shelf for product placement and price tag molding for placement of the price near (usually below) the product. Gondola shelves are about the same length as each gondola or section on the gondola itself.

As used herein the term “flat panel display” refers to electronic visual display technologies both volatile and static. Examples include liquid crystal displays, plasma panels, and light emitting diodes. In general, one flat panel display will fit into the price tag molding, one for each molding, and be about the length of the price tag molding to essentially fill the entire molding with one display.

As used herein the term “electronic means of identification” refers to a digital code within each flat panel display (one for each price tag molding). The digital code is a unique identifier that, when transmitted to the central computer, identifies the store and gondola location. The products on the shelf can thus be associated with the proper flat panel display.

As used herein the term “central computer” refers to a single computer or group of computers, such as servers or the like, wherein the computer or group of computers is digitally connected, i.e. in electronic communication as a unit to the computer in each store, for delivering price information to any shelf or directly to the flat panel display on each shelf. While the central computer can be located anywhere, in one embodiment it is not located in any of the stores being serviced by the central computer.

As used herein the term “electronic communication” refers to the central computer being able to communicate with each flat panel display in each of the plurality of stores. The communication can be over a communication network (e.g. the internet), wireless method, hard wired or the like. It can be directly between the central computer and the flat panel display, or there can be an intermediate computer in one or more stores which takes the information from the central computer and relays it to the flat panel display on each shelf in the store. So, for example, when the price of a box of detergent is determined to be $5.99, the central computer can determine which shelves in which store have the detergent and where it is on the shelf. It can then, all at once, change the price of the detergent in every store all at the same time. This eliminates price discrepancies between stores as well as customer complaints about inconsistent pricing.

As used herein the term “software in resident memory” refers to the central computer having some form of memory, RAM, rom, or the like, which has instructions in digital format for a user at the central computer to program any position on any shelf in the system, this includes all price information as well as advertising or messages of any kind. Because these are flat panel displays, displays of information, movies and the like can be played and can even move from one shelf to the next in a continuous fashion as if they were jumping from one shelf to the next. The higher resolution of these types of shelves allows for information not otherwise producible on low resolution screens. The system could be utilized by a series of connections between screens to lead a customer looking at a first shelf to another shelf at another location in the store by using moving arrows, information or the like, moving from screen to adjacent screens, leading the user to the desired shelf. So, a user standing at the front of the store could be led, a shelf at a time, to a shelf at the back of the store to a particular product, either because of an inquiry for a location or because the store or product manufacturer wants you to visit the shelf.

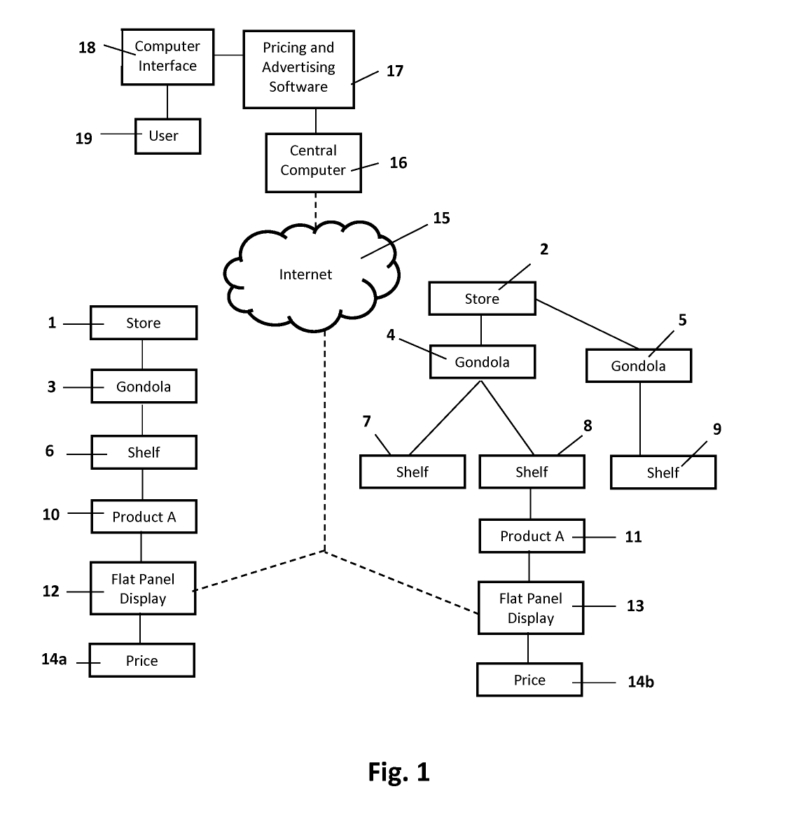

And now referring to the drawings, FIG. 1 is a graphic of the system of the present invention. Store 1 has gondola 3 with shelf 6 and Product A 10 sitting on shelf 6. A flat panel display 12 on shelf 6 is positioned at least partially below the product A 10. Store 2 has gondolas 4 and 5 with shelves 7, 8, and 9. The product A 11 also sits on shelf 8 in store 2. A flat panel display 13 sits below product A on shelf 8.

Both flat panel displays 12 and 13 are connected to internet 15 by a convenient method, either hard wired, or wireless. A central computer 16 is also connected to the internet 15. The location of the central computer 16 can be in one of the stores or someplace other than one of the stores. The central computer 16 has price and advertising software 17 for producing a price, advertisement or the like on a flat panel display. A user 19 uses a computer interface 18 (e.g. a GUI) to work on the central computer 16. The user 19 picks a particular product on a particular shelf in each store. In this case product A 10 and product A 11. The user 19 programs a price for the product A and the central computer 16, via internet 15, sends information to each flat panel display 12 and 13 so that the same price 14a and 14b appears on the flat panel displays simultaneously changing the price in both stores 1 and 2.

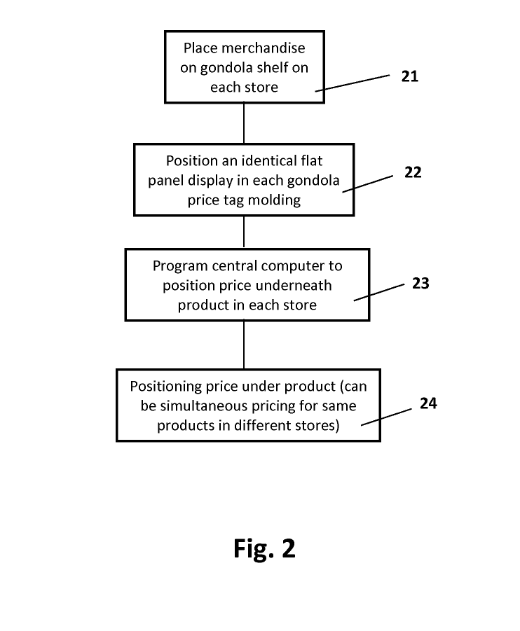

FIG. 2 is a flow chart of the method of the present invention. A worker in each store places a piece of merchandise on a gondola shelf in each store 21. An identified flat panel display is positioned, or has been positioned, in each gondola price tag molding 22. The central computer is programmed to position a price underneath each product in each store 23. This can be done simultaneously with the same or different prices. Lastly, the price is positioned underneath each product for the same product in different stores 24.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the Applicant.

What is claimed is:

1. A system for shelf pricing in multiple stores comprising:
a) a plurality of merchandise stores, each store having one or more gondola shelves displaying merchandise and each shelf having a length, and having a price tag molding, each molding having a length about the length of each shelf;
b) a flat panel display positioned in each price tag molding, the display being about the length of the price tag molding, each flat panel display having an electronic means of identification; and
c) a central computer in electronic communication with each of the identified flat panel displays in the plurality of merchandise stores, the computer having software in resident memory which allows a user of the central computer to position price information next to any of the displayed merchandise from the central computer on at least one flat panel display in at least two stores simultaneously.

2. The system according to claim 1 wherein the electronic communication is communication over an electronic network.

3. The system according to claim 1 wherein the central computer can place messages other than price information on the flat panel displays.

4. The system according to claim 3 wherein the message is an advertisement.

5. The system according to claim 1 wherein the flat panel display is positioned beneath the merchandise.

6. The system according to claim 1 wherein the electronic communication of at least one of the central computer and at least one flat panel display is wireless.

7. The system according to claim 6 wherein the flat panel display wirelessly communicates to a computer in the store and the computer in the store communicates with the central computer.

8. The system according to claim 1 wherein the system is not located in any of the stores.

9. A method of shelf pricing merchandise in a plurality of merchandise stores comprising:
a) placing in each merchandise store one or more gondola shelves displaying merchandise and each shelf having a length, and having a price tag molding, each molding having a length about the length of each shelf;
b) positioning a flat panel display in each price tag molding, the display being about the length of the price tag molding, each flat panel display having an electronic means of identification;
c) programming a central computer in electronic communication with each of the identified flat panel displays in the plurality of merchandise stores, with software in resident memory which allows a user of the central computer to position price information on the identified flat panel display next to each of the displayed merchandise; and
d) positioning a price on the flat panel display next to merchandise on the shelf in at least two stores simultaneously.

10. A method according to claim 9 wherein the central computer can position information other than price information on the flat panel display.

11. A method according to claim 10 wherein the other than price information is advertising.
